(19) United States
(12) Patent Application Publication
(10) Pub. No.: US 2026/0091344 A1
(43) Pub. Date: Apr. 2, 2026

(54) METHOD FOR DEHYDRATION OF A GAS STREAM

(71) Applicant: UOP LLC, Rosemont, IL (US)

(72) Inventors: Scott Lyle Nauert, Chicago, IL (US); Christopher Dyszkiewicz, Burbank, IL (US); Anh Ngo, Cypress, TX (US); Mander Singh, Barrington, IL (US); Jeffrey Tyska, Roselle, IL (US); Shubhra J. Bhadra, Naperville, IL (US); Nasser Khazeni, Arlington Heights, IL (US)

(21) Appl. No.: 19/332,850

(22) Filed: Sep. 18, 2025

Related U.S. Application Data
(60) Provisional application No. 63/702,069, filed on Oct. 1, 2024.

(51) Int. Cl. B01D 53/14; B01D 53/02; B01D 53/26

(52) U.S. Cl. CPC B01D 53/1493; B01D 53/02; B01D 53/1487; B01D 53/261; B01D 2252/103; B01D 2253/108; B01D 2256/22; B01D 2257/70; B01D 2257/80; B01D 2259/4009

(57) ABSTRACT

A method for dehydration of a gas stream is disclosed. The method comprises contacting an oxygenate containing gas stream with a water stream in a contactor column to absorb the oxygenate and provide a washed gas stream. The washed gas stream is contacted with a first adsorbent in a first adsorbent layer to adsorb the oxygenate to provide a first contacted gas stream. The first contacted gas stream is contacted with a second adsorbent in a second adsorbent layer to adsorb water and provide a dehydrated gas stream.

### FIELD

The field is related to a method for dehydration of a gas stream. The field may particularly relate to a method for dehydration of an oxygenate containing gas stream.

### BACKGROUND

There is an increasing demand for chemicals and fuels with low global warming potential. Hydrogen is an important energy source in its own right as a carbon dioxide free heating source as well as for electricity production in fuel cells. Hydrogen is also an important chemical precursor used for production of ammonia for fertilizer and hydrodeoxygenation of biomass intermediates such as fatty acids and triglycerides to produce biofuels.

Many industrial routes for the production of hydrogen start from feedstocks such as biomass, natural gas, or coal. Natural gas can be converted to hydrogen by steam methane reforming, autothermal reforming, or partial oxidation, all of which produce a mixture of hydrogen, carbon monoxide, and carbon dioxide. Coal and biomass can similarly be converted to hydrogen, carbon monoxide, and carbon dioxide by processes such as gasification and reforming. The synthesis gas or syngas formed by gasification, reforming, and partial oxidation processes may be further transformed by water gas shift reactions to form more hydrogen and carbon dioxide.

Carbon dioxide containing streams produced by water gas shift, biomass gasification, and reforming may contain volatile oxygenates such as alcohols, aldehydes, ketones, and esters. Water gas shift processes produce methanol and ethanol byproducts at typical process temperatures and pressures. Biomass gasification and reforming produces volatile oxygenates such as methanol, ethanol, formaldehyde, acetaldehyde, and methyl formate.

Demand exists to capture and utilize or store the carbon dioxide produced in processes such as hydrogen production. Cryogenic separation is an important process for separating carbon dioxide from other components. The carbon dioxide must be substantially free of water or it can freeze under cryogenic conditions, therefore the carbon dioxide containing streams must be dehydrated before carbon dioxide separation.

Materials used for dehydrating gas streams can coke during regeneration in the presence of oxygenates, leading to loss of water adsorption capacity and increased pressure drop. This applies to dehydration of carbon dioxide containing streams as well as other streams which may contain oxygenates such as hydrogen, methane, and natural gas streams. The propensity for coking is related to the type of the adsorbent used, with microporous materials such as zeolites and materials with more acid sites having a higher propensity for coking than other materials such as activated carbon, silica gel, and some aluminosilicates.

There is therefore a need to control oxygenate concentration when dehydrating gas streams containing oxygenates such as hydrogen, carbon dioxide, methane, and natural gas streams.

### BRIEF SUMMARY

The present disclosure comprises a method for dehydration of a gas stream. The method comprises contacting an oxygenate containing gas stream with a water stream in a contactor column to absorb the oxygenate and provide a washed gas stream. The washed gas stream is contacted with a first adsorbent in a first adsorbent layer to adsorb the oxygenate to provide a first contacted gas stream. The first contacted gas stream is contacted with a second adsorbent in a second adsorbent layer to adsorb water and provide a dehydrated gas stream. The disclosed method reduces the coking of adsorbents under regeneration conditions which increases adsorbent capacity, reduces pressure drop, and increases adsorbent lifetime.

### BRIEF DESCRIPTION OF THE DRAWINGS

FIG. 1 is a simplified process flow diagram of a method for dehydration of a gas stream in accordance with an embodiment of the present disclosure.

FIG. 2 is a plot that shows predicted outlet concentrations for an amorphous silica gel for a feed comprising methanol and water in accordance with an exemplary embodiment of the present disclosure.

### DEFINITIONS

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without passing through a fractionation or conversion unit to undergo a compositional change due to physical fractionation or chemical conversion.

The term “indirect communication” means that flow from the upstream component enters the downstream component after passing through a fractionation or conversion unit to undergo a compositional change due to physical fractionation or chemical conversion.

The term “bypass” means that the object is out of downstream communication with a bypassing subject at least to the extent of bypassing.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take a main product from the bottom.

The term “contactor column” means a vessel for contacting liquid and vapor to enable mass transfer between components. Examples of a contactor column may include a falling-film column, packed column, plate column, bubble column, spray tower, or venturi scrubber. Feeds to the columns may be precooled. The top pressure is the pressure of the overhead vapor at the vapor outlet of the column. The bottom temperature is the liquid bottom outlet temperature.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” means greater than 50%, suitably greater than 75% and preferably greater than 90%.

As used herein, the term “Cₓ” is to be understood to refer to molecules having the number of carbon atoms represented by the subscript “x”. Similarly, the term “Cₓ-” refers to molecules that contain less than or equal to x and preferably x and less carbon atoms. The term “Cₓ+” refers to molecules with more than or equal to x and preferably x and more carbon atoms.

As used herein, the term “carbon number” refers to the number of carbon atoms per hydrocarbon molecule and typically a paraffin molecule.

As used herein, the term “carbon number” refers to the number of carbon atoms per hydrocarbon molecule and typically a paraffin molecule.

As used herein, the term “passing” includes “feeding” and means that the material passes from a conduit or vessel to an object.

As used herein, the term “oxygenate” refers to hydrocarbonaceous oxygenates but does not include water unless otherwise indicated.

As used herein, the term “rich” can mean an amount of at least generally 50%, and preferably 70%, more preferably 90% or above by mass of a compound or class of compounds in a stream.

As used herein, the prefix “bio” refers to an association with a renewable resource of biological origin, such resources generally being exclusive of fossil fuels.

As used herein, the term “biofuel,” as defined herein, is a fuel product at least partly derived from “biomass,” the latter being a renewable resource of biological origin.

As used herein, the term “oxygenate” refers to any molecule containing carbon, hydrogen, and at least one oxygen atom.

### DETAILED DESCRIPTION

The present disclosure provides a method for dehydration of an oxygenate containing gas stream. The oxygenate may include alcohol such as methanol and/or ethanol. The method includes water wash of the gas stream followed by a multi-bed adsorbent system to adsorb the oxygenate and the remnant water from the gas stream. The multi-bed adsorbent system may comprise at least a methanol-resistant adsorbent layer followed by a molecular sieve layer to dehydrate the gas feed. The disclosed method prevents breakthrough of methanol to the molecular sieve layer and provides dehydration of the gas stream to less than about 20 ppm water or lower while avoiding loss of adsorbent capacity due to coking. The combination of these steps enables deep dehydration capability while maintaining adsorbent lifetime in the presence of variable oxygenate concentration.

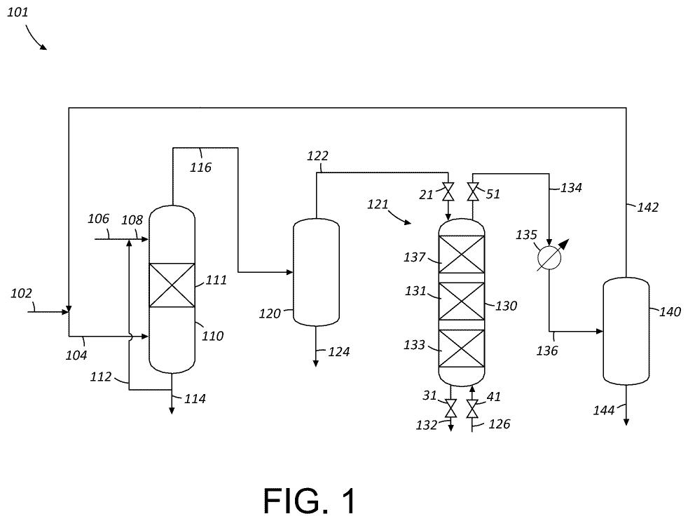

Referring to FIG. 1, a method for dehydration of a gas stream is disclosed. The method 101 comprises a contactor column 110 and an adsorption unit 121. As shown, an oxygenate containing gas stream is provided in line 102 and passed to the contactor column 110. In an aspect, the oxygenate containing gas stream provided in line 102 is a carbon dioxide rich gas stream. In another aspect, the oxygenate containing gas stream provided in line 102 is a hydrogen rich gas stream.

In accordance with the present disclosure, the oxygenate containing gas stream provided in line 102 may be taken from a hydrogen production unit. A hydrogen production unit may include, but is not limited to, one or more of a gasifier unit, reforming unit such as gasified biomass reforming, steam methane reforming, autothermal reforming, a partial oxidation unit, a water gas shift unit, or an electrochemical hydrogen production unit. A feed to the hydrogen production unit may include, but are not limited to, methane, natural gas, liquified petroleum gas, naphtha, coal, biomass, and the like, or combinations thereof. In accordance with the present disclosure, the oxygenate containing gas stream provided in line 102 may be taken from a carbon dioxide rich gas stream. The carbon dioxide rich gas stream may be taken from one or more of a pipeline, a biogas unit, a fermentation unit, a methanol production unit, or a blast furnace unit. While the embodiments of the present disclosure are described with respect to hydrogen purification and carbon dioxide capture processes, it is to be understood by those of ordinary skill in the art that the embodiments herein may be utilized in or adapted for use in other types of industrial applications that require water removal from a stream comprising oxygenates in addition to hydrogen purification and carbon dioxide capture. The biomass may include “biorenewable feedstock” which includes feedstocks other than those obtained from crude oil. The biorenewable feedstock may include any of those feedstocks which comprise at least one of cellulose, hemicellulose and lignin. Examples of these biorenewable feedstocks include wood, algae, fungus, agricultural residues such as corn stover, rice straw, wheat straw, and bagasse, switchgrass, miscanthus, and other grasses, pulp and paper processing waste, lumber mill wastes, and municipal solid waste. As will be appreciated, the biorenewable feedstock may comprise a mixture of one or more of the foregoing examples. The biorenewable feedstock may be pretreated to remove contaminants. The biorenewable feedstock may comprise a nitrogen concentration of about 50 wppm to about 20,000 wppm. The biorenewable feedstock may comprise high oxygen content which can be up to 10 wt % or higher. The biorenewable feedstock may also comprise about 1 wppm to about 5,000 wppm sulfur.

The biorenewable feedstock may be cracked in a cracking unit such as a thermochemical gasifier unit or catalytic gasifier unit to produce a cracked stream comprising hydrogen and carbon oxides. The cracked stream may be reformed in a reforming unit to produce a reformed stream. The cracked or reformed streams may be processed in a water gas shift unit to provide a shifted stream.

Syngas is defined as a gas comprising primarily carbon monoxide (CO), carbon dioxide (CO2) and hydrogen (H2). Optionally, syngas may also include methane (CH4), and small amounts of ethane, propane, and oxygenates.

The syn gas production zone may comprise a syngas reactor. Suitable syngas reactors include, but are not limited to, a steam reforming unit, or an autothermal reforming unit with an optional gas heated reformer, or a gasification unit, or a partial oxidation (POX) unit, dry reforming unit, or combinations thereof. The composition of the synthesis gas may vary depending on the process used to produce it. For example, a typical synthesis gas composition (on a dry basis) from a biomass gasification unit may be 20 to 50 mol % carbon monoxide, 20 to 40 mol % molecular hydrogen, 0 to 10 mol % methane, 10 to 30 mol % carbon dioxide, 0 to 2 mol % nitrogen, and 0 to 0.5 mol % argon.

The carbon oxide containing gaseous stream is reformed with steam in a steam reforming reactor, an autothermal reforming reactor, or a dry reforming reactor. Water gas shift reaction also occurs in the reformer.

In an aspect, the syn gas is a green syn gas produced from the biorenewable feedstock.

In an aspect, the syn gas is shifted to predominantly hydrogen and carbon dioxide in one or more water gas shift units to form a shifted syn gas stream. The composition of the shifted syn gas may vary depending on the conditions in the water gas shift units. For example, a shifted syn gas stream composition (on a dry basis) may be about 40 mol % to about 60 mol % carbon dioxide, about 40 to about 60 mol % hydrogen, about 0 to about 10 mol % methane, about 0 to about 2 mol % nitrogen, about 0 to about 10 mol % methane, and about 0 to about 5,000 ppm-mol methanol.

In an aspect, the oxygenate containing stream 102 may be an off gas from a methanol synthesis unit. The methanol synthesis unit may comprise one or more methanol converters in a methanol synthesis section to produce a crude methanol stream which may be purified in a purification section. An off-gas stream comprising carbon oxides, and some methanol is also separated from the methanol synthesis section. The off-gas stream comprising carbon oxides and methanol is provided in line 102 and passed to the contactor column for separating methanol and also water removal as described later in detail.

In an exemplary embodiment, the oxygenate containing gas stream in line 102 may comprise from about 1000 ppmv to about 5000 ppmv water and about 100 ppmv to about 2000 ppmv methanol. In some cases, the oxygenate containing gas stream in line 102 may include about 100 ppmv to about 2000 ppmv ethanol.

In an aspect, the oxygenate containing gas stream in line 102 may be produced from a water gas shift reaction.

In an embodiment, the oxygenate containing gas stream in line 102 may be combined with a recycled vapor stream in line 142 to provide a combined gas stream in line 104. The combined gas stream in line 104 is passed to the contactor column 110. A water stream in line 106 is passed to the contactor column 110. In the contactor column 110, the combined gas stream in line 104 is counter-currently contacted with the water stream in line 106 to produce a washed gas stream. The contactor column 110 may comprise one or more of sprayer, packing, or trays 111 for contacting the water stream in line 106 with the combined gas stream in line 104. In an exemplary embodiment, the contactor column 110 is a water wash column. When contacted, the water absorbs a majority of the oxygenates from the combined gas stream to produce the washed gas stream comprising a lower concentration of oxygenate as compared to the combined gas stream in line 104. The washed gas stream is discharged in line 116 from a top of the contactor column 110. A contacted water stream comprising oxygenates is discharged in line 114 from the bottoms of the contactor column 110. In an embodiment, the washed gas stream in line 116 comprises no more than 200 ppmv oxygenate, or no more than 100 ppmv oxygenate, or no more than 50 ppmv oxygenate. In an exemplary embodiment, the washed gas stream in line 116 comprises about 100 ppmv to about 200 ppmv oxygenate. The washed gas stream in line 116 may be a washed carbon dioxide rich gas stream.

In an embodiment, a portion of the contacted water stream in line 114 may optionally be recycled in recycled water line 112 to the contactor column 110. In an embodiment, the recycled contacted water stream in line 112 may be combined with the water stream in line 106 to form a combined water stream in line 108 and directed to the contactor column 110. The ratio of recycled water in line 112 to the fresh water in line 106 may be adjusted to achieve a desired methanol concentration in the washed gas stream in line 116.

The washed gas stream in line 116 may be passed to a coalescer 120 to separate water in droplets from the gaseous components. The coalescer 120 may be any suitable coalescer for separating water droplets. Coalescers which may be used include vertical or horizontal vessels containing a coalescing filter element. Coalescing filter elements comprise fibers which promote the growth of droplets. The coalescing filter element may be a bed or mat comprising or consisting of fibers. In other cases, the coalescing filter element may comprise cartridges of fibers through which the gas stream is passed. Coalescers may include a baffle or screen element before the fiber element to remove larger droplets or slugs of water.

Water droplets are separated in the coalescer 120 and discharged in line 124 from the bottom of the coalescer 120. The washed gas stream is taken in line 122 from the coalescer 120. The washed gas stream in line 122 is passed to the adsorption unit 121.

In an aspect, the coalescer 120 is optionally used and the washed gas stream in line 116 is directly passed to the adsorption unit 121.

The adsorption unit 121 may be a multi-bed adsorbent unit. The adsorption unit 121 may comprise one or more adsorption vessels comprising one or more adsorbent beds for contacting the washed gas stream with a plurality of adsorbents to adsorb oxygenate and water to produce a dehydrated gas stream depleted of the oxygenate.

In an exemplary embodiment, the multi-bed adsorbent unit 121 is a temperature swing adsorption (TSA) type adsorbent unit.

TSA processes rely on the fact that at low temperature, gases tend to adsorb within the pore structure of microporous or mesoporous adsorbent materials or within the free volume of a polymeric material. When the temperature of the adsorbent is increased, the adsorbed gas is released, or desorbed. By cyclically swinging the temperature of adsorbent beds, TSA processes can be used to separate gases in a mixture when used with an adsorbent that is selective for one or more of the components in a gas mixture.

TSA processes employ an adsorbent that is repeatedly cycled through at least two steps—an adsorption step and a thermally assisted regeneration step. Regeneration of the adsorbent can be achieved by heating the adsorbent to an effective temperature to desorb target components from the adsorbent. The adsorbent can then be cooled so that another adsorption step can be completed. Thermal swing adsorption process can be conducted with rapid cycles, in which case they are referred to as rapid cycle thermal swing adsorption (RCTSA). A rapid cycle thermal swing adsorption process is defined as one in which the cycle time between successive adsorption steps is less than about 10 minutes, preferably less than about 2 minutes, for example less than about 1 minute. RCTSA processes can be used to obtain very high product recoveries in the excess of 90 vol %, for example greater than 95 vol % or, in some cases, greater than 98 vol %. The term “adsorption” as used herein includes physisorption, chemisorption, and condensation in the pore structure or free volume of a solid adsorbent, and combinations thereof.

The adsorption unit 121 may comprise more than one adsorption vessel 130. In such an embodiment, one or more adsorption vessels may be coupled in a heating/cooling operation and others may be involved in adsorption and/or desorption operation.

The adsorption separation in the adsorption unit 121 may be performed at a temperature ranging from about 10° C. to about 150° C., or from about 20° C. to about 80° C. Absolute pressures during the adsorption step may range from about 1 bar (a) to about 100 bar (a), or from about 10 bar (a) to about 60 bar (a).

The adsorption step can be stopped at a predetermined point before the adsorption front breaks through the product output end of the adsorbent bed. Alternately, the adsorption step can be conducted for a fixed period of time set by the feed flow rate and adsorbent capacity. Further additionally or alternately, the adsorption step can be conducted for a time less than about 72 hours, preferably less than about 24 hours, or less than about 12 hours or less than about 8 hours. In some instances, the adsorption front can be allowed to break through the output end only for a short duration such as at most a few seconds, but it is usually preferred that the adsorption front not be allowed to break through.

The term “breakthrough” is defined herein as the point where the product gas exiting an adsorbent layer exceeds the target specification of a contaminant component. At the breakthrough point, the adsorbent layer can be considered “spent”, such that any further operation through the spent adsorption layer will result in higher than specification contaminant passing through the spent adsorbent layer. If the spent adsorbent layer is not the last or final adsorbent layer in an adsorbent bed, this may reduce the capacity or lifetime of subsequent adsorbent layers by irreversible adsorption or coking during regeneration. If the spent adsorbent layer is the final or last adsorbent layer in an adsorbent bed, this may produce an off-specification product gas.

For regeneration of the spent adsorbent bed, external heating may be provided to pass heat through the spent adsorbent bed, as it transitions from the adsorption step to the regeneration step. For example, a hot fluid may be flowed through the adsorption bed to raise the adsorbent temperature. The hot fluid would take out the desorbed material from the spent adsorbent which will end up dispersed in a spent hot fluid.

In an exemplary embodiment, the adsorption unit 121 comprises an adsorption vessel 130 comprising a first adsorbent layer 131 of a first adsorbent and a second adsorbent layer 133 of a second adsorbent. The first adsorbent layer 131 inside the adsorption vessel 130 is placed at location upstream or in front of the second adsorbent layer 133 such that the washed gas stream in line 122 upon entering the adsorption vessel 130 comes into contact with first adsorbent layer 131 first.

In accordance with the present disclosure, the adsorption vessel 130 comprises a first adsorbent layer 131 which can adsorb and tolerate a higher oxygenate concentration such as of the order of about 100 ppm mol and above to provide an oxygenate depleted gas stream. Further, the adsorption vessel 130 comprises a second adsorbent layer 133 which can include a molecular sieve to dehydrate the oxygenate depleted gas stream and provide a dehydrated gas stream. In some instances, water may be allowed to break through the second adsorbent layer 133 for only a short duration such as at most a few seconds, but it is usually preferred that the water not be allowed to break through the second adsorbent layer 133.

In an aspect, the first adsorbent in the first adsorbent layer 131 may comprise one or more of an amorphous silica gel, an amorphous aluminosilicate, an activated alumina, or an activated carbon. In an exemplary embodiment, the first adsorbent in the first adsorbent layer 131 comprises a low-alumina silica gel comprising less than about 10 wt % alumina.

In an embodiment, the second adsorbent in the second adsorbent layer 133 may comprise a zeolite. In an exemplary embodiment, the second adsorbent layer comprises a zeolite exchanged with at least one of lithium, sodium, potassium, magnesium, and calcium. In another embodiment, the second adsorbent layer 133 comprises a zeolite with topology selected from LTA, FAU, CHA, MFI, or BEA. In an embodiment, the second adsorbent layer 133 comprises one or more of zeolite A, zeolite X, or zeolite Y. In another embodiment, the second adsorbent layer 133 comprises zeolite 13X, zeolite 3A, zeolite 4A, or zeolite 5A.

When the washed gas stream in line 122 is passed to the adsorption vessel 130, the washed gas stream comes into contact with the first adsorbent layer 131. The first adsorbent layer 131 adsorbs the oxygenate such as methanol from the washed gas stream as it passes through the first adsorbent layer 131 to provide a first contacted gas stream with reduced oxygenate mole fraction. In an embodiment, the first contacted gas stream comprises an oxygenate mole fraction no more than about 100 ppm, or no more than about 50 ppm, or no more than about 20 ppm, or no more than about 2 ppm, or no more than about 1 ppm. In an embodiment, the reduced mole fraction of oxygenate is maintained for at least 90%, or at least 95%, or at least 98%, or at least 99% of the duration of the contacting step in the first adsorbent layer 131.

The second adsorbent may have at least twice the acid sites as the first adsorbent. The first adsorbent comprises lesser acid sites as compared to the second adsorbent. In an aspect, the first adsorbent may comprise about half or 50% acid sites as compared to the second adsorbent on a per mass basis. In another aspect, the first adsorbent may comprise no more than about half or 50% acid sites as compared to the second adsorbent on a per mass basis. It is expected that the second adsorbent may have at least twice the weak acid sites as the first adsorbent. Because the first adsorbent adsorbs most if not all of the oxygenates in the first adsorbent layer, the oxygenates do not make it to the acid sites on the second adsorbent in the second adsorbent layer where they can cause coking during regeneration.

The first adsorbent in the first adsorbent layer 131 adsorbs about 50% or more and preferably all the oxygenate from the washed gas stream for at least 90% of the of the duration of the contacting step and provides the first contacted gas stream depleted of the oxygenate. The first contacted gas stream flows downwards to the second adsorbent layer 133. The first contacted gas stream contacts the second adsorbent in the second adsorbent layer 133. The second adsorbent adsorbs water from the first contacted gas stream to provide a dehydrated gas stream. In an embodiment, the water mole fraction in the dehydrated gas stream is less than or equal to about 20 ppm, or about 10 ppm, or about 5 ppm, or about 1 ppm, or about 0.5 ppm.

The dehydrated gas stream is discharged in product gas line 132 from the adsorption vessel 130 as dry product stream. The dehydrated gas stream in line 132 may be a dehydrated carbon dioxide gas stream. The dehydrated gas stream may be discharged from the bottom of the adsorption vessel 130 in a downflow arrangement, or from the top of the adsorption vessel 130 in an upflow arrangement. The dehydrated gas stream in line 132 may predominately comprise carbon dioxide and hydrogen with small amounts of nitrogen, argon, carbon monoxide, and methane. In an aspect, the second adsorbent of the second adsorbent layer 133 may comprise a crystalline molecular sieve.

In some embodiments, the second adsorbent in the second adsorbent layer 133 comprises a majority of the open pore volume attributable to microporous pore diameters, for example in which no more than 40%, more preferably no more than 20%, for example no more than 10%, of its open pore volume can originate from pore diameters no less than 20 angstroms and no more than about 1 micron (i.e., from mesoporous and macroporous pore diameters). By “open pore volume” herein, it is meant all of the open pore space not occupied in the volume encompassed by the adsorbent material. The open pore volume includes all open spaces in the volume encompassed by the adsorbent material, including but not limited to all volumes within the adsorbent materials themselves, including the pore volume of the structured or amorphous materials, as well as any interstitial open volumes within the structure of the portion of the bed containing the adsorbent material.

In an exemplary embodiment, the dehydrated gas stream in line 132 may comprise no more than about 20 ppmv water and about zero ppmv oxygenate.

In an optional embodiment, the adsorption vessel 130 may comprise a third adsorbent layer 137 comprising an aluminosilicate adsorbent at a location upstream or in front of the first adsorbent layer 131 such that the washed gas stream in line 122 comes into contact with the third adsorbent layer 137 first upon entering the adsorption vessel 130. The third adsorbent layer 137 protects the downstream first adsorbent and the second adsorbent from any aerosol or liquid water that may be present in the washed gas stream. The third adsorbent layer 137 may adsorb or vaporize any aerosol or liquid water. The third adsorbent may have an amorphous structure.

At the end of the adsorption step, the flow of the washed gas stream in line 122 to the adsorption vessel 130 may be stopped by closing the valve 21 on the washed gas in line 122 and closing valve 31 on the product gas in line 132, and the regeneration cycle of the adsorption vessel 130 may be started. For regeneration, a regeneration gas stream in line 126 is passed counter-currently to the flow of the washed gas stream inside the adsorption vessel 130 by opening the valve 41 on the regeneration gas in line 126 and opening valve 51 on the spent regeneration gas in line 134. So, if the washed gas stream in line 122 is passed to a top of the adsorption vessel 130, the regeneration gas stream in line 126 is passed to the bottom of the adsorption vessel 130. The regeneration gas stream in line 126 comes into contact with a spent second adsorbent layer first and then to a spent first adsorbent layer to regenerate the first adsorbent layer and the second adsorbent layer. In an embodiment, the regeneration gas stream in line 126 may be first heated and a heated regeneration gas stream is passed to the adsorption vessel 130 in line 126 by opening the valve 41 for regenerating the spent adsorbents. In an exemplary embodiment, the regeneration gas stream may be heated to a temperature of about 200° C. (392° F.) to about 300° C. (572° F.) to provide the heated regeneration gas stream. During regeneration of adsorption vessel 130, the washed gas stream in line 122 may be passed to a second adsorption vessel in the adsorption unit 121 to provide a continuous process.

In an exemplary embodiment, the regeneration gas stream in line 126 may comprise a slip stream taken from the dehydrated gas stream in line 132.

During regeneration, a spent regeneration gas stream is produced which is taken out of the adsorption vessel 130 through the open valve 51 on the spent regeneration gas line 134. The spent regeneration gas stream in line 134 comprises water and oxygenate which may be recovered. The spent regeneration gas stream in line 134 may be cooled in a cooler 135 to provide a cooled spent regeneration gas in line 136. The cooled spent regeneration gas in line 136 is passed to a knock-out-drum (KOD) 140 to separate condensed regeneration gas in line 144. A vaporous spent regeneration gas stream is taken in line 142 from the KOD 140. The vaporous spent regeneration gas stream in line 142 is recycled to the contactor column 110. In an embodiment, the vaporous spent regeneration gas stream in line 142 is combined with the oxygenate containing gas stream in line 102 to provide the combined gas stream in line 104 and separated as described previously. In an embodiment, the vaporous spent regeneration gas stream in line 142 may be pressurized by suitable device, for example, a regeneration gas blower, before being combined with the oxygenate containing gas stream in line 102.

In an aspect, the dehydrated gas stream in line 132 may be passed to a cryogenic separation section downstream of the adsorption unit 121. The dehydrated gas stream in line 132 should comprise no more than about 20 ppmv water to prevent water freezing in the cryogenic section. Cryogenic separation may comprise purification of carbon dioxide by distillation for carbon capture for utilization or storage. In another aspect, the dehydrated gas stream in line 132 may be passed to a pressure swing adsorption (PSA) unit to separate hydrogen to make a hydrogen product stream.

### EXAMPLES

### Example 1

Acid site density was measured for a low-alumina amorphous silica gel with <5 wt % alumina content and a 4A zeolite by ammonia temperature programmed desorption. The adsorbents were dried at elevated temperature under flowing air, cooled, then exposed to ammonia until they were saturated. The samples were then purged in an inert gas, and the temperature was ramped to 800° C. and held. Desorbed ammonia was measured by a thermal conductivity detector, and the amount of ammonia desorbed was assigned to the acid site density of the material. The measured acid site density for the low-alumina amorphous silica gel was 100±10 μmol/g, and the measured acid site density for the 4A zeolite was 1150±100 μmol/g. Materials with lower acid site density have a lower propensity for coking during regeneration in the presence of adsorbed oxygenates, so the low-alumina amorphous silica gel should have a lower coking rate than 4A zeolite for an oxygenate containing feed in a temperature swing adsorption cycle.

### Example 2

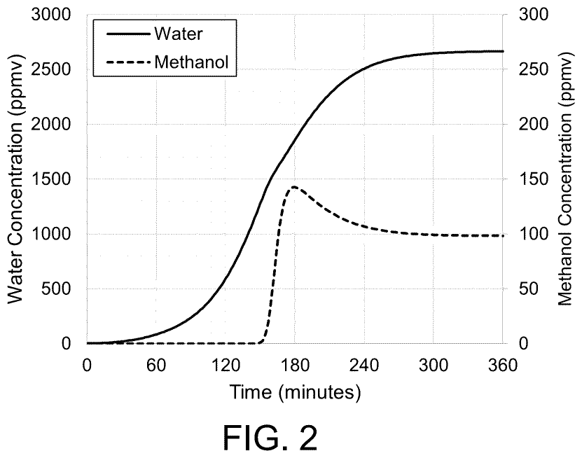

Competitive adsorption of methanol and water was simulated on a low-alumina amorphous silica gel. A feed gas at 104° F. and 609 psig comprising 2665 ppmv water, 98 ppmv methanol, 42% carbon dioxide, and the balance nitrogen was fed to a bed of amorphous silica gel adsorbent with length to diameter ratio of about 0.75 at a rate of 40 lb-mol gas/lb adsorbent/minute until breakthrough of both methanol and water. FIG. 2 shows the predicted outlet concentration for water and methanol over time. At these conditions, methanol breakthrough, defined here as the time at which methanol concentration exceeds 10% of the feed concentration, was not predicted to occur until after 150 minutes. Water breakthrough, defined here as the time at which water concentration exceeds 20 ppmv, was predicted to occur within 30 minutes of adsorption, however some water was removed by the bed for the 150 minutes before methanol breakthrough. This illustrates that a first adsorbent layer comprising a low-alumina amorphous silica gel can effectively remove oxygenates such as methanol in the presence of water. This is beneficial to protect a downstream adsorbent which may otherwise have reduced adsorbent capacity or lifetime in a temperature swing adsorption cycle if exposed to oxygenates. The observance of water breakthrough before methanol breakthrough illustrates that it is beneficial to use a second adsorbent layer to remove remaining water that may break through the first adsorbent layer.

### Example 3

The process of FIG. 1 was simulated. A feed gas stream in line 102 with 254 million standard cubic feet per day (MMSCFD) flow rate at 104° F., 618 psig, 2400 ppmv water, and 700 ppmv methanol was combined with regeneration gas in line 142 with 48 MMSCFD flow rate at 144° F., 618 psig, 3800 ppmv water, and 200 ppmv methanol and fed to the contactor column 110. The combined gas stream was contacted with 68 gpm fresh water at 104° F. in line 106 and 82.5 gpm recirculating water in line 112, and the resulting washed gas in line 116 had 2666 ppmv water and 100 ppmv methanol at 107° F. The washed gas stream was fed to adsorption unit 121 to provide the dehydrated gas stream in line 132. The adsorption unit 121 had three adsorbent beds on adsorption, with each bed comprising a first adsorbent layer with 13,250 lb low-alumina silica gel followed by a second adsorbent layer with 8,650 lb of 4A zeolite. At the end of the adsorption cycle, the predicted methanol concentration at the end of the first adsorbent layer was less than 1 ppmv, and the predicted water concentration in the dehydrated gas stream in line 132 was less than 1 ppmv. These results show that a contactor column can effectively remove bulk methanol from a feed gas stream to be dehydrated, and that a first adsorbent layer in an adsorption unit can effectively remove all methanol before a feed stream contacts a second adsorbent layer.

### Specific Embodiments

While the following is described in conjunction with specific embodiments, it will be understood that this description is intended to illustrate and not limit the scope of the preceding description and the appended claims.

A first embodiment of the present disclosure is a method for dehydration of a gas stream, comprising contacting an oxygenate containing gas stream with a water stream in a contactor column to absorb the oxygenate and provide a washed gas stream; contacting the washed gas stream with a first adsorbent in a first adsorbent layer to adsorb the oxygenate to provide a first contacted gas stream; and contacting the first contacted gas stream with a second adsorbent in a second adsorbent layer to adsorb water and provide a dehydrated gas stream. An embodiment of the present disclosure is one, any or all of prior embodiments in this paragraph up through the first embodiment in this paragraph, wherein the gas stream is a carbon dioxide rich gas stream. An embodiment of the present disclosure is one, any or all of prior embodiments in this paragraph up through the first embodiment in this paragraph, wherein the washed gas stream comprises less than about 200 ppm oxygenate. An embodiment of the present disclosure is one, any or all of prior embodiments in this paragraph up through the first embodiment in this paragraph, wherein the first contacted gas stream comprises less than about 100 ppm oxygenate for at least 90% of a duration of the contacting step. An embodiment of the present disclosure is one, any or all of prior embodiments in this paragraph up through the first embodiment in this paragraph, wherein the first adsorbent comprises one or more of an amorphous silica gel, an amorphous aluminosilicate, an activated alumina, or an activated carbon. An embodiment of the present disclosure is one, any or all of prior embodiments in this paragraph up through the first embodiment in this paragraph, wherein the second adsorbent comprises a zeolite. An embodiment of the present disclosure is one, any or all of prior embodiments in this paragraph up through the first embodiment in this paragraph, wherein the first adsorbent comprises less than about 50% acid sites as compared to the second adsorbent on a per mass basis. An embodiment of the present disclosure is one, any or all of prior embodiments in this paragraph up through the first embodiment in this paragraph, wherein the dehydrated gas stream comprises less than about 20 ppm water. An embodiment of the present disclosure is one, any or all of prior embodiments in this paragraph up through the first embodiment in this paragraph, wherein the oxygenate comprises one or both of methanol and ethanol. An embodiment of the present disclosure is one, any or all of prior embodiments in this paragraph up through the first embodiment in this paragraph, wherein the first contacting step produces an oxygenate containing water stream and a portion of the oxygenate containing water stream is recycled in the water stream to the contactor column. An embodiment of the present disclosure is one, any or all of prior embodiments in this paragraph up through the first embodiment in this paragraph further comprising taking a regeneration gas stream from the dehydrated gas stream; heating the regeneration gas stream to provide a heated regeneration gas stream; and passing the heated regeneration gas stream counter-currently to the second adsorbent layer and then to the first adsorbent layer to regenerate the first adsorbent layer and the second adsorbent layer. An embodiment of the present disclosure is one, any or all of prior embodiments in this paragraph up through the first embodiment in this paragraph further comprising taking a spent regeneration gas stream from the first adsorbent layer; cooling the spent regeneration gas stream to provide a cooled spent regeneration gas stream; separating liquid from the cooled spent regeneration gas stream to provide a vapor spent regeneration gas stream; and charging the vapor spent regeneration gas stream to the contactor column. An embodiment of the present disclosure is one, any or all of prior embodiments in this paragraph up through the first embodiment in this paragraph wherein the regeneration gas stream is heated to a temperature of about 200° C. to about 300° C. to provide the heated regeneration gas stream. An embodiment of the present disclosure is one, any or all of prior embodiments in this paragraph up through the first embodiment in this paragraph, wherein the second adsorbent layer comprises a zeolite exchanged with at least one of lithium, sodium, potassium, magnesium, and calcium. An embodiment of the present disclosure is one, any or all of prior embodiments in this paragraph up through the first embodiment in this paragraph, wherein the oxygenate containing gas stream is taken from a water gas shift process. An embodiment of the present disclosure is one, any or all of prior embodiments in this paragraph up through the first embodiment in this paragraph further comprises contacting the washed gas stream with a third adsorbent layer comprising an aluminosilicate adsorbent to provide a contacted washed gas stream; and passing the contacted washed gas stream to the first adsorbent layer.

A second embodiment of the present disclosure is a method for dehydration of a gas stream, comprising contacting a carbon dioxide rich gas stream comprising alcohol with a water stream in a contactor column to absorb the alcohol and provide a washed carbon dioxide rich gas stream; contacting the washed carbon dioxide rich gas stream with a first adsorbent in a first adsorbent layer to adsorb the alcohol to provide a contacted carbon dioxide rich gas stream; and contacting the contacted carbon dioxide rich gas stream with a second adsorbent in a second adsorbent layer to adsorb water to provide a dehydrated carbon dioxide rich gas stream. An embodiment of the present disclosure is one, any or all of prior embodiments in this paragraph up through the second embodiment in this paragraph, wherein the first adsorbent layer comprises one or more of an amorphous silica gel, an amorphous aluminosilicate, an activated alumina, or an activated carbon. An embodiment of the present disclosure is one, any or all of prior embodiments in this paragraph up through the second embodiment in this paragraph, wherein the second adsorbent layer comprises a zeolite. An embodiment of the present disclosure is one, any or all of prior embodiments in this paragraph up through the second embodiment in this paragraph further comprising taking a regeneration carbon dioxide stream from the dehydrated carbon dioxide rich gas stream; heating the regeneration carbon dioxide stream to form a heated regeneration carbon dioxide gas stream; and passing the heated regeneration gas stream counter-currently to the second adsorbent layer and then to the first adsorbent layer to regenerate the first adsorbent layer and the second adsorbent layer.

A third embodiment of the present disclosure is a method for dehydration of a gas stream, comprising contacting an alcohol containing gas stream with water in a contactor column to absorb the oxygenate and provide a washed gas stream; contacting the washed gas stream with a first adsorbent in a first adsorbent layer to adsorb the alcohol to provide a first contacted gas stream, the first adsorbent comprising one or more of an amorphous silica gel, an amorphous aluminosilicate, an activated alumina, or an activated carbon; and contacting the first contacted gas stream with a second adsorbent in a second adsorbent layer to adsorb water to provide a dehydrated gas stream, the second adsorbent comprising a zeolite.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A method for dehydration of a gas stream, comprising:
contacting an oxygenate containing gas stream with a water stream in a contactor column to absorb the oxygenate and provide a washed gas stream;
contacting said washed gas stream with a first adsorbent in a first adsorbent layer to adsorb the oxygenate to provide a first contacted gas stream; and
contacting said first contacted gas stream with a second adsorbent in a second adsorbent layer to adsorb water and provide a dehydrated gas stream.

2. The method of claim 1, wherein said gas stream is a carbon dioxide rich gas stream.

3. The method of claim 1, wherein said washed gas stream comprises less than about 200 ppm oxygenate.

4. The method of claim 1, wherein said first contacted gas stream comprises less than about 100 ppm oxygenate for at least 90% of a duration of the contacting step.

5. The method of claim 1, wherein the first adsorbent comprises one or more of an amorphous silica gel, an amorphous aluminosilicate, an activated alumina, or an activated carbon.

6. The method of claim 1, wherein the second adsorbent comprises a zeolite.

7. The method of claim 1, wherein the first adsorbent comprises less than about 50% acid sites as compared to the second adsorbent on a per mass basis.

8. The method of claim 1, wherein said dehydrated gas stream comprises less than about 20 ppm water.

9. The method of claim 1, wherein the oxygenate comprises one or both of methanol or ethanol.

10. The method of claim 1, wherein said first contacting step produces an oxygenate containing water stream and a portion of said oxygenate containing water stream is recycled in the water stream to the contactor column.

11. The method of claim 1 further comprising:
taking a regeneration gas stream from said dehydrated gas stream;
heating said regeneration gas stream to provide a heated regeneration gas stream; and
passing said heated regeneration gas stream counter-currently to the second adsorbent layer and then to the first adsorbent layer to regenerate the first adsorbent layer and the second adsorbent layer.

12. The method of claim 11 further comprising:
taking a spent regeneration gas stream from the first adsorbent layer;
cooling said spent regeneration gas stream to provide a cooled spent regeneration gas stream;
separating liquid from said cooled spent regeneration gas stream to provide a vapor spent regeneration gas stream; and
charging said vapor spent regeneration gas stream to the contactor column.

13. The method of claim 11 wherein said regeneration gas stream is heated to a temperature of about 200° C. to about 300° C. to provide said heated regeneration gas stream.

14. The method of claim 1, wherein the second adsorbent layer comprises a zeolite exchanged with at least one of lithium, sodium, potassium, magnesium, and calcium.

15. The method of claim 2, wherein the oxygenate containing gas stream is taken from a water gas shift process.

16. The method of claim 1 further comprises:
contacting said washed gas stream with a third adsorbent layer comprising an aluminosilicate adsorbent to provide a contacted washed gas stream; and
passing said contacted washed gas stream to the first adsorbent layer.

17. A method for dehydration of a gas stream, comprising:
contacting a carbon dioxide rich gas stream comprising alcohol with a water stream in a contactor column to absorb the alcohol and provide a washed carbon dioxide rich gas stream;
contacting said washed carbon dioxide rich gas stream with a first adsorbent in a first adsorbent layer to adsorb the alcohol to provide a contacted carbon dioxide rich gas stream; and
contacting said contacted carbon dioxide rich gas stream with a second adsorbent in a second adsorbent layer to adsorb water to provide a dehydrated carbon dioxide rich gas stream.

18. The method of claim 17, wherein the first adsorbent layer comprises one or more of an amorphous silica gel, an amorphous aluminosilicate, an activated alumina, or an activated carbon.

19. The method of claim 17, wherein the second adsorbent layer comprises a zeolite.

20. The method of claim 17 further comprising:
taking a regeneration carbon dioxide stream from said dehydrated carbon dioxide rich gas stream;
heating said regeneration carbon dioxide stream to form a heated regeneration carbon dioxide gas stream; and
passing said heated regeneration gas stream counter-currently to the second adsorbent layer and then to the first adsorbent layer to regenerate the first adsorbent layer and the second adsorbent layer.

21. A method for dehydration of a gas stream, comprising
contacting an alcohol containing gas stream with water in a contactor column to absorb the oxygenate and provide a washed gas stream;
contacting said washed gas stream with a first adsorbent in a first adsorbent layer to adsorb the alcohol to provide a first contacted gas stream, the first adsorbent comprising one or more of an amorphous silica gel, an amorphous aluminosilicate, an activated alumina, or an activated carbon; and
contacting said first contacted gas stream with a second adsorbent in a second adsorbent layer to adsorb water to provide a dehydrated gas stream, the second adsorbent comprising a zeolite.
